(19) United States
(12) Patent Application Publication
(10) Pub. No.: US 2013/0100040 A1
(43) Pub. Date: Apr. 25, 2013

(54) MULTIFORM MULTISCREEN ELECTRONIC DEVICE

(71) Applicants: Marcus Jerome Haynes, Painted Post, NY (US); Matthew McGowan, Austin, TX (US); Timothy James Morton, Austin, TX (US); Paul Jay Tompkins, Geneva, NY (US); Donnell Thaddeus Walton, Painted Post, NY (US)

(72) Inventors: Marcus Jerome Haynes, Painted Post, NY (US); Matthew McGowan, Austin, TX (US); Timothy James Morton, Austin, TX (US); Paul Jay Tompkins, Geneva, NY (US); Donnell Thaddeus Walton, Painted Post, NY (US)

(21) Appl. No.: 13/278,452

(22) Filed: Oct. 21, 2011

(51) Int. Cl. G09G 5/00; G06F 3/041

(52) U.S. Cl. 345/173; 345/1.3

(57) ABSTRACT

A multiform multiscreen electronic device includes a first electronic device, a second electronic device, and a third electronic device. The first electronic device has a first electronic device screen integrated with a frontside of a first electronic device body. The second electronic device has a second electronic device screen integrated with a frontside of a second electronic device body, and the second electronic device body is coupled to the first electronic device body by a first hinge. The third electronic device body has a third electronic device screen integrated with a frontside of a third electronic device body, and the third electronic device body is coupled to the second electronic device body by a second hinge.

### TECHNICAL FIELD

The invention relates generally to handheld electronic devices with multiple screens.

### BACKGROUND

U.S. Patent Publication No. 2010/075717 A1 (Ou; published 25 Mar. 2010) discloses a handheld electronic device having a first body, a second body, and a pivot mechanism between the first body and second body.

### SUMMARY

In one aspect of the invention, a multiform multiscreen electronic device comprises a first electronic device having a first electronic device screen integrated with a frontside of a first electronic device body. The multiform multiscreen electronic device includes a second electronic device having a second electronic device screen integrated with a frontside of a second electronic device body, where the second electronic device body is coupled to the first electronic device body by a first hinge. The multiform multiscreen electronic device further includes a third electronic device having a third electronic device screen integrated with a frontside of a third electronic device body, where the third electronic device body is coupled to the second electronic device body by a second hinge.

In one embodiment, the first and second hinges are 180-degree hinges.

In one embodiment, the first hinge is configured to permit the second electronic device body to be folded to a position in which a backside of the second electronic device body is in opposing relation to a backside of the first electronic device body.

In one embodiment, the second hinge is configured to permit the third electronic device body to be folded to a position in which the frontside of the third electronic device body is in opposing relation to the frontside of the second electronic device body.

In one embodiment, the first electronic device further comprises a processor integrated with the first electronic device body.

In one embodiment, the first electronic device further comprises a camera integrated with the first electronic device body.

In one embodiment, the first electronic device further comprises a wireless communications device integrated with the first electronic device body.

In one embodiment, the first electronic device further comprises a plurality of touch-sensitive buttons integrated with the first electronic device body.

In one embodiment, the first electronic device further comprises a plurality of touch-sensitive buttons integrated with the third electronic device body.

In one embodiment, the first electronic device further comprises a battery disposed in the first electronic device body.

In one embodiment, the first electronic device further comprises contact points integrated with the first electronic device body for inductive charging of the battery.

In one embodiment, a microphone is integrated with the first electronic device body.

In one embodiment, a loudspeaker is integrated with the first electronic device body.

In one embodiment, a loudspeaker is integrated with the third electronic device body.

In one embodiment, the multiform multiscreen electronic device further comprises at least an arm for forming an angle brace between the first electronic device body and the second electronic device body or between the second electronic device body and the third electronic device body.

In one embodiment, each of the first, second, and third electronic device screens has one or more screen areas, where each screen area is selected from the group consisting of a display screen area, a touchscreen area, and an input screen area.

In one embodiment, each of the first, second, and third electronic bodies has a backside made of scratch-resistant glass.

In one embodiment, the first, second, and third electronic device screens are operatively coupled.

In one embodiment, at least one of the first, second, and third electronic devices comprises a sensor for detecting an orientation of its respective electronic device screen.

In one embodiment, the electronic device bodies are configurable in a form selected from the group consisting of a stacked form, a flat or tablet form, a L-shaped form, a V-shaped form, and a Z-shaped form.

It is to be understood that both the foregoing general description and the following detailed description are exemplary of the invention and are intended to provide an overview or framework for understanding the nature and character of the invention as it is claimed. The accompanying drawings are included to provide a further understanding of the invention and are incorporated in and constitute a part of this specification. The drawings illustrate various embodiments of the invention and together with the description serve to explain the principles and operation of the invention.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 illustrates a multiform multiscreen electronic device in stacked form.

FIG. 2 illustrates the multiform multiscreen electronic device in flat or tablet form.

FIG. 3 illustrates the multiform multiscreen electronic device in L-shaped form.

FIG. 4 illustrates the multiform multiscreen electronic device in another L-shaped form.

FIG. 5 illustrates the multiform multiscreen electronic device in Z-shaped form.

FIG. 6 is a block diagram of components included in the main electronic device of the multiform multiscreen electronic device of FIGS. 1-5.

FIGS. 7A-7C illustrate various orientations of a first extension electronic device relate to a main electronic device where the two are coupled together by a 180-degree hinge.

FIGS. 8A-8C illustrate various orientations of a second extension electronic device relate to a first extension electronic device where the two are coupled together by a 180-degree hinge.

### DETAILED DESCRIPTION

In the following detailed description, numerous specific details may be set forth in order to provide a thorough understanding of embodiments of the invention. However, it will be clear to one skilled in the art when embodiments of the invention may be practiced without some or all of these specific details. In other instances, well-known features or processes may not be described in detail so as not to unnecessarily obscure the invention. In addition, like or identical reference numerals may be used to identify common or similar elements.

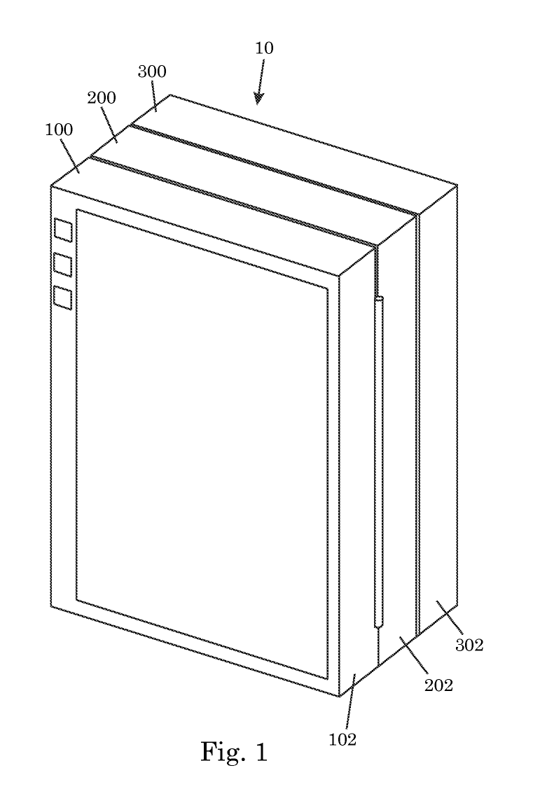

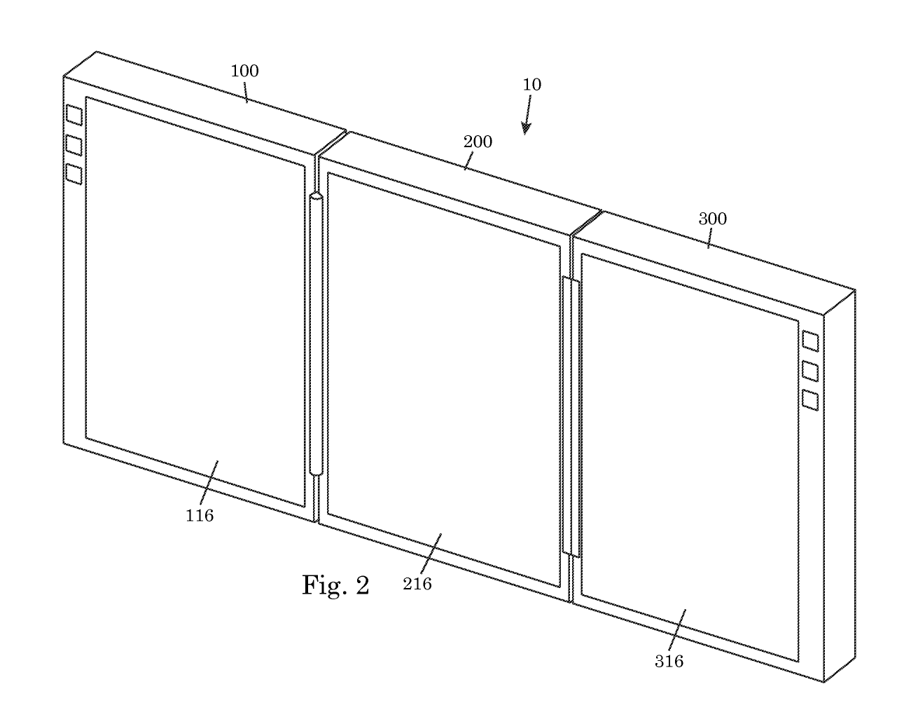

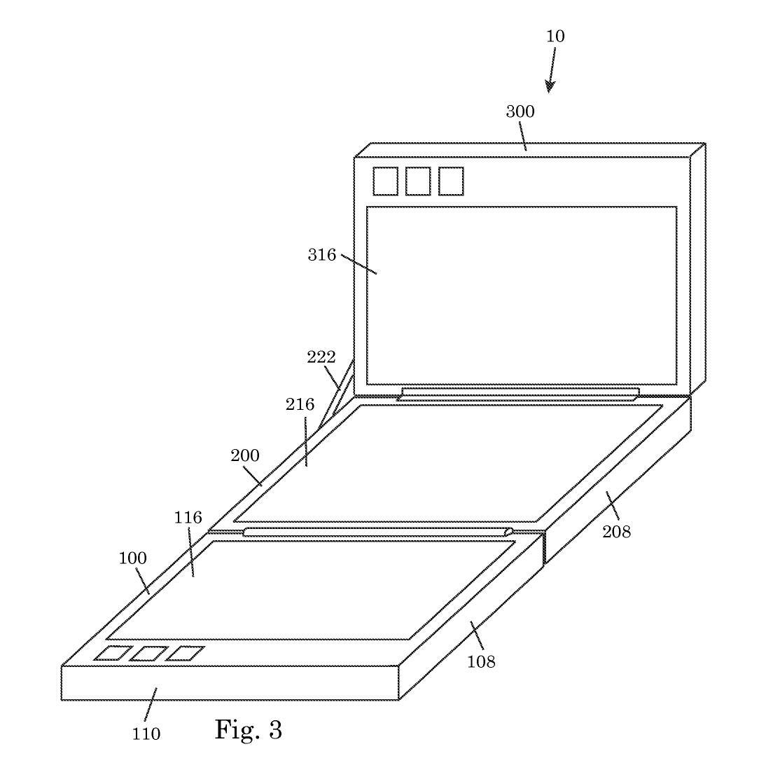

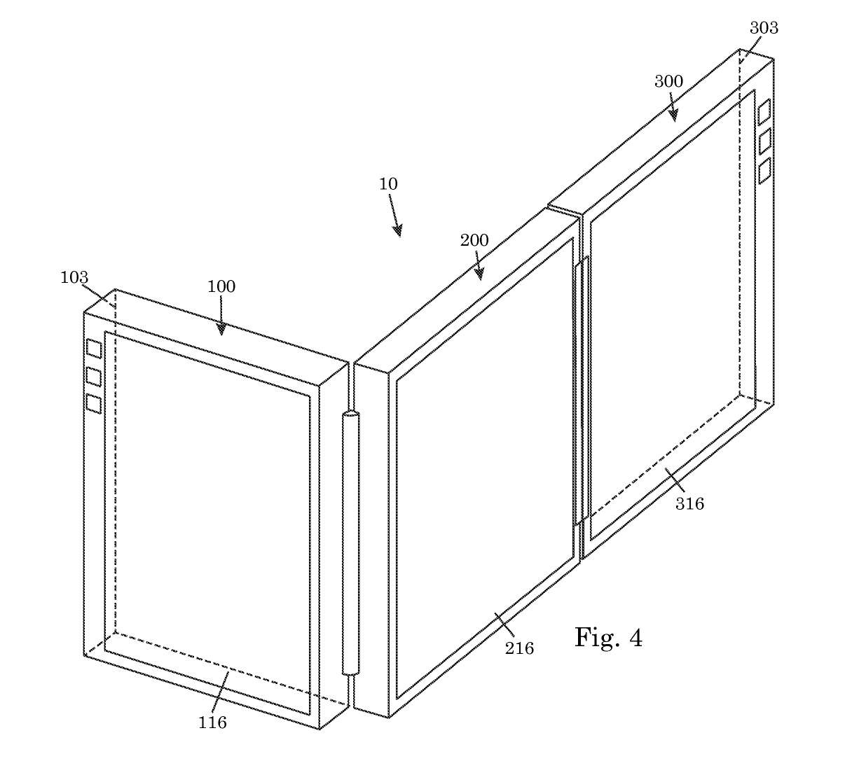

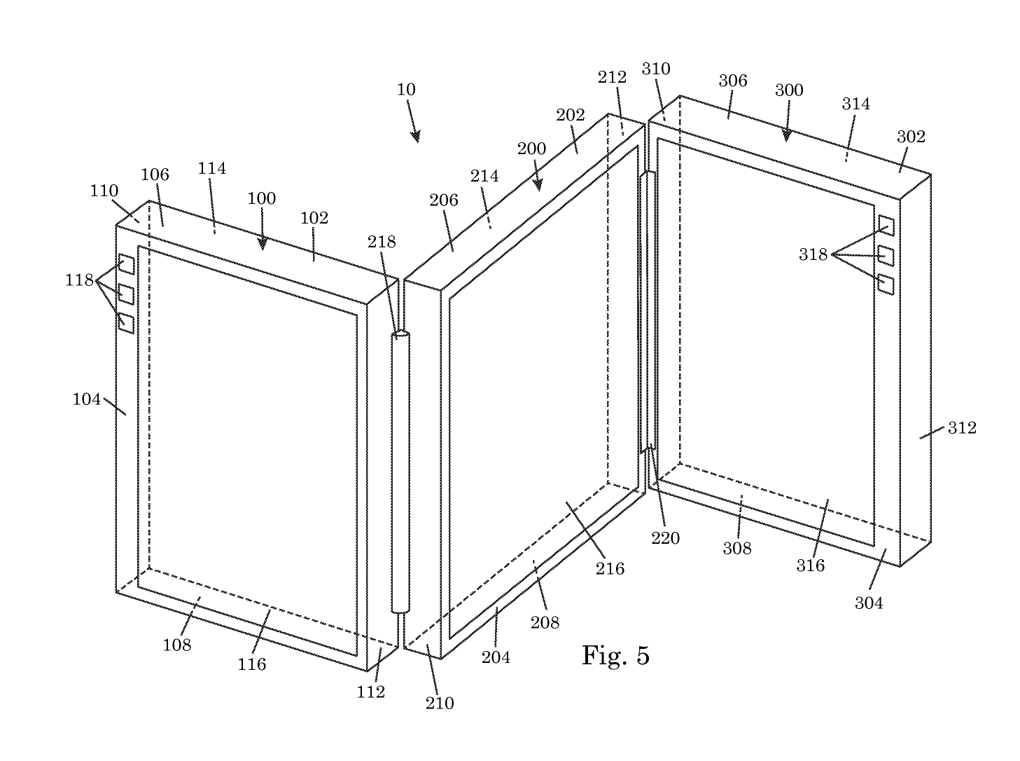

In FIG. 1, a multiform multiscreen electronic device 10 has a main electronic device 100, a first extension electronic device 200, and a second extension electronic device 300. Each of the electronic devices 100, 200, 300 has an associated screen (116, 216, 316, respectively, in FIG. 2). In the closed position (shown in FIG. 1), the electronic devices 100, 200, 300 are in a stacked form. In the open position, the multiform multiscreen electronic device 10 can have a variety of forms, e.g., a flat or tablet form (shown in FIG. 2), L-shaped forms (shown in FIGS. 3 and 4), and a Z-shaped form (shown in FIG. 5). The L-shaped form shown in FIG. 4 may be turned so that it becomes a V-shaped form, although with one leg of the V being longer than the other. The multiform multiscreen electronic device 10 can have a variety of uses in its variety of forms. For example, in the stacked form of FIG. 1, the multiform multiscreen electronic device 10 can function as a smartphone. In the flat or tablet form of FIG. 2, the multiform multiscreen electronic device 10 can function as a slate tablet. In the flat or tablet form, all the screens of the electronic devices 100, 200, 300 combine to provide a triple-sized screen. In the L-shaped form of FIG. 3, the multiform multiscreen electronic device 10 can function as a notebook computer. In the L-shaped form of FIG. 4 (which can also be a V-shaped form), the multiscreen electronic device 10 can be function as a game center, where one user interacts with a game from a screen on one leg of the L-shaped form and the other user interacts with the game from a screen on the other leg of the L-shaped form. In the L-shaped forms of FIGS. 3 and 4, two screens out of the three screens associated with the electronic devices 100, 200, 300 combine to provide a double-sized screen. In the Z-shaped form, the multiform multiscreen electronic device 10 can function as a trifold display. Other forms and uses of the multiform multiscreen electronic device 10 besides those mentioned above are possible. The electronic devices 100, 200, 300 are coupled together by hinges that allow them to fold and unfold into the various forms of the multiform multiscreen electronic device 100.

In FIG. 5, the main electronic device 100 has a main electronic device body 102, which is generally rectangular in shape. All the components of the main electronic device 100 are integrated with, or disposed on or in, the main electronic device body 102 so that the components and the main electronic device body 102 function as a whole. The main electronic device body 102 may be made of a single material or a combination of materials. The main electronic device body 102 may be made of durable plastic or metal, e.g., aluminum. In one embodiment, the frontside 104, top and bottom edges 106, 108 (the bottom edge 108 is parallel and opposite to the top edge 106), and side edges 110, 112 (the side edge 112 is parallel and opposite to the side edge 110) of the main electronic device body 102 are made of durable plastic or metal, and the backside 114 (the backside 114 is parallel and opposite to the frontside 104) of the main electronic device body 102 is made of glass. Preferably, the glass is a scratch-resistant glass. The main electronic device body 202 may be made thicker or contoured near the side edge 110 to facilitate gripping of the main electronic device 100 by hand.

The main electronic device 100 has a main electronic device screen 116 that is integrated with the main electronic device body 102 such that it is visible and usable from the frontside 104 of the main electronic device body 102. The main electronic device screen 116 may have one or more screen areas, each of which may be a display screen area, a touchscreen area, or an input screen area. The main electronic device screen 116 may be based on any suitable flat-panel screen technology, such as LCD technology or OLED technology. The main electronic device 100 may have touch-sensitive buttons 118 near its side edge 110. The touch-sensitive buttons 118 may be used to interact with the main electronic device 100 as well as with the extension electronic devices 200, 300. For example, the touch-sensitive buttons 118 may be used to access menus and navigate the various screens of the multiform multiscreen electronic device 10.

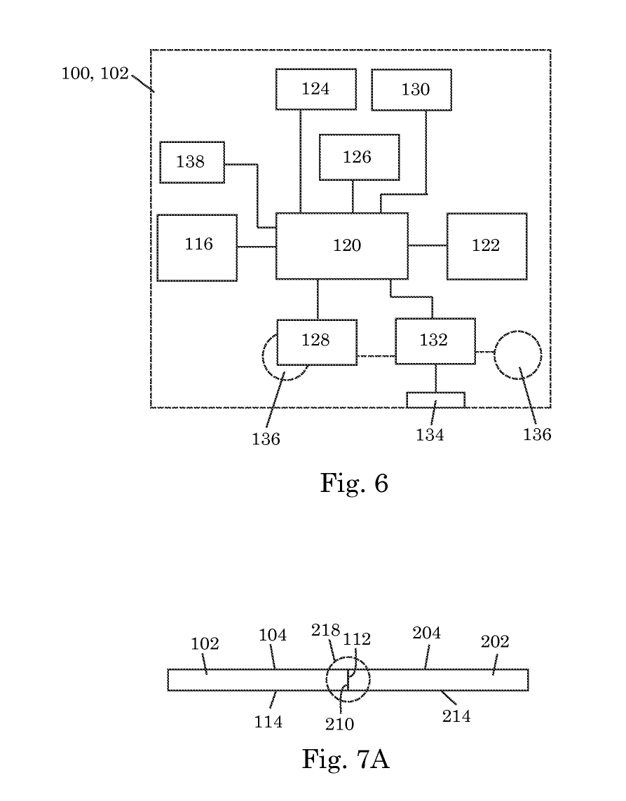

In FIG. 6, the main electronic device 100 has a processor 120 to execute and manage its operations and interactions with the extension electronic devices 200, 300 (in FIGS. 1-5). The main electronic device 100 has memory 122 for storing data. The main electronic device 100 may have components typically associated with smart phones, such as loudspeaker 124, microphone 126, wireless communications device(s) 128, and camera 130. In one embodiment, the wireless communications device(s) 128 may include any combination of 3G/4G cellular antenna or other GPS antenna, WiFi antenna, and Bluetooth device.

The main electronic device 100 has a battery 132 for powering its operations as well as that of the extension electronic devices 200, 300. The main electronic device 100 may have an electrical charging port 134 for direct charging of the battery 132. For such direct charging, a cable is connected to the port 134 and an external electrical power source. Alternatively, the main electronic device 100 may have contact points 136 for inductive charging. The contact points 136 may be located on the backside 114 (in FIG. 5) of the main electronic device body 102 to allow interaction with the main electronic device 100 while the battery is being charged.

The main electronic device 100 may be equipped with orientation sensor(s) 138, e.g., accelerometer(s). The orientation sensor(s) 138 may be used to sense the orientation of the main electronic device 100 and cause a change in the display orientation of the main electronic device screen 116 as needed, e.g., so that the screen 116 may be used in portrait or landscape orientation.

In FIG. 5, the first extension electronic device 200 has a first extension electronic device body 202, which is generally rectangular in shape. All the components of the first extension electronic device 200 are integrated with, or disposed in or on, the first extension electronic device body 202 so that the components and first extension electronic device body 202 function as a whole. The first extension electronic device body 202 may be made of a single material or a combination of materials. The first extension electronic device body 202 may be made of durable plastic or metal, e.g., aluminum. In one embodiment, the frontside 204, top and bottom edges 206, 208 (the bottom edge 208 is parallel and opposite to the top edge 206), and side edges 210, 212 (the side edge 212 is parallel and opposite to the side edge 210) of the first extension electronic device body 202 are made of durable plastic or metal, and the backside 214 (the backside 214 is parallel and opposite to the frontside 204) of the first extension electronic device body 202 is made of glass. Preferably, the glass is a scratch-resistant glass.

The first extension electronic device 200 has a first extension electronic device screen 216 that is integrated with the first extension electronic device body 202 such that it is visible and usable from the frontside 204 of the first extension electronic device body 202. The first extension electronic device screen 216 may have one or more screen areas, each of which may be a display screen area, a touchscreen area, or an input screen area. The first extension electronic device screen 216 may be based on any suitable flat-panel screen technology, such as LCD technology or OLED technology.

The first extension electronic device 200 may be equipped with orientation sensor(s) such as shown at 138 in FIG. 6 for the main electronic device 100. The orientation sensor(s) may be used to sense the orientation of the first extension electronic device and cause a change in the display orientation of the first extension electronic device screen 216 as needed, e.g., so that the screen 216 may be used in portrait or landscape orientation.

In FIG. 5, the second extension electronic device 300 has a second extension electronic device body 302, which is generally rectangular in shape. All the components of the second extension electronic device 300 are integrated with, or disposed on or in, the second extension electronic device body 302 so that the components and second extension electronic device body 302 function as a whole. The second extension electronic device body 302 may be made of a single material or a combination of materials. The second extension electronic device body 302 may be made of durable plastic or metal, e.g., aluminum. In one embodiment, the frontside 304, top and bottom edges 306, 308 (the bottom edge 308 is parallel and opposite to the top edge 306), and side edges 310, 312 (the side edge 310 is parallel and opposite to the side edge 312) of the first extension electronic device body 302 are made of durable plastic or metal, and the backside 314 (the backside 314 is parallel and opposite to the frontside 304) of the second extension electronic device body 302 is made of glass. Preferably, the glass is a scratch-resistant glass. The second extension electronic device body 302 may be made thicker or contoured near the side edge 312 to facilitate gripping of the second extension electronic device 300 by hand.

The second extension electronic device 300 has a second extension electronic device screen 316 that is integrated with the second extension electronic device body 302 such that it is visible and usable from the frontside 304 of the second extension electronic device body 302. The second extension electronic device screen 316 may have one or more screen areas, each of which may be a display screen area, a touchscreen area, or an input screen area. The second extension electronic device screen 316 may be based on any suitable flat-panel screen technology, such as LCD technology or OLED technology. The second extension electronic device 300 may have touch-sensitive buttons 318, such as capacitive buttons, near its side edge 312. The buttons 318 may be used to interact with the second extension electronic device 300, e.g., to access menus or navigate the second extension electronic device screen 316. The second extension electronic device screen 316 may be based on any suitable flat-panel screen technology, such as LCD technology or OLED technology. Although not visible in the drawing, the second extension electronic device 300 may also include a microphone and a loudspeaker.

The second extension electronic device 300 may be equipped with orientation sensor(s) such as shown at 138 in FIG. 6 for the main electronic device 100. The orientation sensor(s) may be used to sense the orientation of the second extension electronic device and cause a change in the display orientation of the second extension electronic device screen 316 as needed, e.g., so that the screen 316 may be used in portrait or landscape orientation.

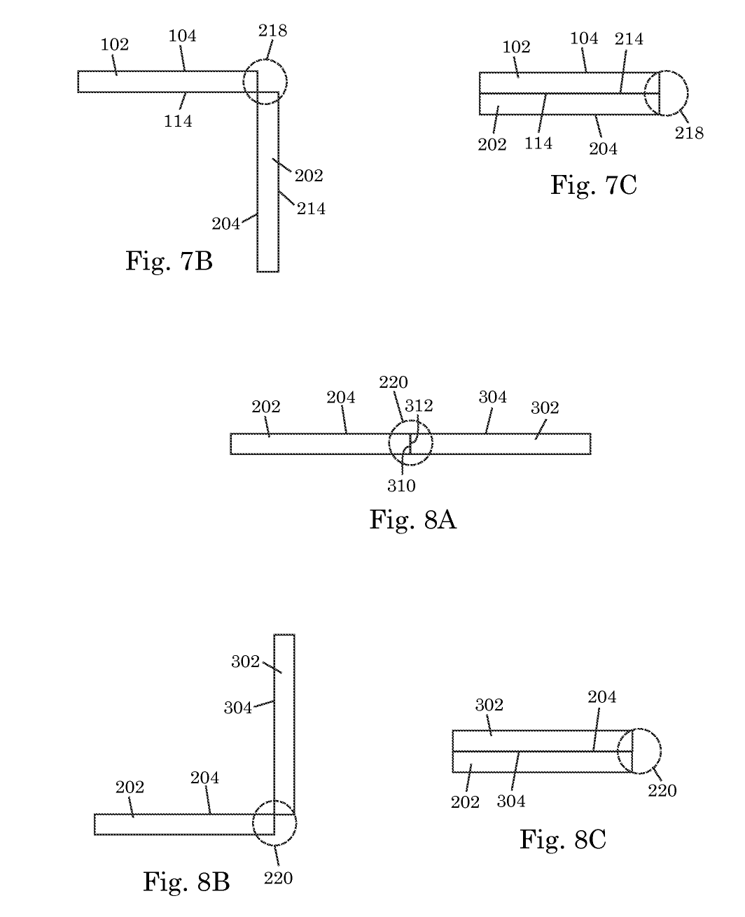

In FIG. 5, the side edge 210 of the first extension electronic device body 202 is coupled to the side edge 112 of the main electronic device body 102 by a hinge 218. In one embodiment, the hinge 218 is a 180-degree hinge. A 180-degree hinge allows up to 180 degrees angle of rotation between two solid objects that it connects. In the convention used here, the 180-degree hinge is at its 0-degree or 180-degree position when the two objects that it connects are parallel to each other and at its 90-degree position when the two objects that it connects are perpendicular to each other. The 180-degree hinge has numerous other positions between the 0-degree and 90-degree positions and between the 90-degree and 180-degree positions. FIGS. 7A-7C illustrate three orientations of the first extension device body 202 relative to the main electronic device body 102. However, there are many more possible orientations of the first extension device body 202 relative to the main electronic device body 102 because there are infinitely many degrees between 0 and 180 degrees.

In FIG. 7A, the orientation of the first extension device body 202 relative to the main electronic device body 102 at the 0-degree position of the 180-degree hinge 218 is shown. The first extension electronic device body 202 is parallel to the main electronic device body 102. The side edge 210 of the first extension electronic device body 202 is in opposing relation to the side edge 112 of the main electronic device body 102. Also, the first extension electronic device screen 216 (in FIGS. 2 and 3) can be flush with the main electronic device screen 116 (in FIGS. 2 and 3) so that the electronic device screens 116, 216 effectively combine to form a double-sized electronic device screen.

In FIG. 7B, the orientation of the first extension device body 202 relative to the main electronic device body 102 at the 90-degree position of the 180-degree hinge 218 is shown. In this position, the first extension electronic device body 202 is perpendicular to the main electronic device body 102.

In FIG. 7C, the orientation of the first extension device body 202 relative to the main electronic device body 102 at the 180-degree position of the 180-degree hinge 218 is shown. The first extension electronic device body 202 is parallel to the main electronic device body 102. The backside 214 of the first extension electronic device body 202 is in opposing relation to the backside 114 of the main electronic device body 102. In other words, the first extension electronic device body 202 is stacked behind or below the main electronic device body 102. The first extension electronic device screen 216 (in FIGS. 2-5) may or may not be visible and usable depending on the orientation of the second extension electronic device body 302 (in FIGS. 2-5) to the first extension electronic device body 202.

In FIG. 5, the side edge 212 of the first extension electronic device body 202 is coupled to the side edge 310 of the second extension electronic device body 302 by a hinge 220. In one embodiment, the hinge 220 is a 180-degree hinge. The 180-degree hinge 220 is oriented backwards compared to the 180-degree hinge 218. This is to allow the first extension electronic device body 202 and the second extension electronic device body 302 to fold in different directions to achieve the stacked form of FIG. 1. Relative to FIG. 5, the hinge 218 could be thought of as a counterclockwise hinge, while the hinge 220 could be thought of as a clockwise hinge.

In FIG. 8A, the orientation of the second extension electronic device body 302 relative to the first extension electronic device body 202 at the 0-degree position of the 180-degree hinge 220 is shown. Here, the second extension electronic device body 302 is parallel to the first extension electronic device body 202. The side edge 310 of the second extension electronic device body 302 is in opposing relation to the side edge 212 of the first extension electronic device body 202. The second extension electronic device screen 316 (in FIGS. 2 and 4) can be practically flush with the first extension electronic device screen 216 (in FIGS. 2 and 4) so that the extension device screens 216, 316 effectively combine to form a double-sized screen.

In FIG. 8B, the orientation of the second extension electronic device body 302 relative to the first extension electronic device body 202 at the 90-degree position of the 180-degree hinge 220 is shown. Here, the second extension electronic device body 302 is perpendicular to the first extension electronic device body 202.

In FIG. 8C, the orientation of the second extension electronic device body 302 relative to the first extension electronic device body 202 at the 180-degree position of the 180-degree hinge 220 is shown. Here, the second extension electronic device body 302 is parallel to the first extension electronic device body 202. The frontside 304 of the second extension electronic device body 302 is in opposing relation to the frontside 204 of the first extension electronic device body 202. In other words, the second extension electronic device body 302 is stacked above or in front of the first extension electronic device body 202.

Various permutations of the positions of the hinges 218, 220 can be used to transform the multiform multiscreen electronic device 10 into various forms. For example, the stacked form shown in FIG. 1 can be formed by rotating the 180-degree hinge 218 to the 180-degree position (see FIG. 7C) and the 180-degree hinge 220 to the 180-degree position (see FIG. 8C). In this form, only the main electronic device screen 116 would be visible and usable.

The flat or tablet form shown in FIG. 2 can be formed by rotating the 180-degree hinge 218 to the 0-degree position (see FIG. 7A) and the 180-degree hinge 220 to the 0-degree position (see FIG. 8A). In this flat or tablet form, all the three electronic device screens 116, 216, 316 would be visible and usable and effectively combine to form a triple-sized screen.

For the L-shaped form shown in FIG. 3, the 180-degree hinge 218 would be at its 0-degree position (see FIG. 7A) and the 180-degree hinge 220 would be at its 90-degree position (see FIG. 8A). In this L-shaped form, the electronic extension device screens 116, 216 would combine to form a double-sized screen. The hinge 220 should be strong enough to hold the screen 316 up in the L-shaped form. For additional support, one or two arms 222 may be used to brace the first extension electronic device body 202 to the main electronic device body 202. The arm 222 may be retractable so that it can be out of sight when not needed.

One or more arms similar to arm 222 may also be used between the first extension electronic device body 202 and main electronic device body 102 in the L-shaped form shown in FIG. 4, especially if the L-shaped form is turned so that it rests on the corner edges 103, 303 of the main electronic device body 102 and second extension electronic device body 302, respectively, forming a V-shaped form—in this case the arm may help maintain the V shape. The other forms shown in FIGS. 4 and 5 can be similarly constructed by manipulation of the positions of the hinges 218, 220.

The electronic devices 100, 200, 300 (in FIGS. 1-5) are in communication, with the main electronic device 100 providing power to the extension electronic devices 200, 300 and controlling interaction of the user(s) with the extension electronic devices 200, 300. Wired connections may be used for power and data signals exchange between the electronic devices 100, 200, 300. The wired connections may be made through the hinges 218, 220 (in FIG. 5) so that the connections are hidden from view. Alternatively, the electronic devices may communicate using wireless technology, such as Bluetooth technology. In this case, the electronic devices 200, 300 should be equipped with wireless communications devices. Secondary batteries may also be included in the extension electronic device bodies 202, 302 (in FIG. 5) for storing power received from the main electronic device 100.

The multiform multiscreen device 10 of FIGS. 1-5 can be configured to be used in a variety of ways. In one example, the main electronic device 100 may function as a central information hub for most applications such as social networking application, map applications, and email applications. When running an email application, a list of emails can be listed on the main electronic device screen 116, with the body of a selected email shown on the first extension electronic device screen 216 or the second extension electronic device screen 316. When running a map application, turn-by-turn directions can be shown on the main electronic device screen 116, with a corresponding map shown on the first extension electronic device screen 216 and/or the second extension electronic device screen 316. The three screens 116, 216, 316 can also allow interaction with multiple applications at the same time. For example, a video or movie can be playing on the first extension electronic device screen 216 and the second extension electronic device screen 316 while the main electronic device screen 116 can display email or some other application that can be run at the same time as the video application.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A multiform multiscreen electronic device, comprising:
a first electronic device comprising a first electronic device screen integrated with a frontside of a first electronic device body;
a second electronic device comprising a second electronic device screen integrated with a frontside of a second electronic device body, the second electronic device body being coupled to the first electronic device body by a first hinge; and
a third electronic device having a third electronic device screen integrated with a frontside of a third electronic device body, the third electronic device body being coupled to the second electronic device body by a second hinge.

2. The multiform multiscreen electronic device of claim 1, the first hinge and second hinge are 180-degree hinges.

3. The multiform multiscreen electronic device of claim 1, wherein the first hinge is configured to permit the second electronic device body to be folded to a position in which a backside of the second electronic device body is in opposing relation to a backside of the first electronic device body.

4. The multiform multiscreen electronic device of claim 3, wherein the second hinge is configured to permit the third electronic device body to be folded to a position in which the frontside of the third electronic device body is in opposing relation to the frontside of the second electronic device body.

5. The multiform multiscreen electronic device of claim 4, wherein the first electronic device further comprises a processor integrated with the first electronic device body.

6. The multiform multiscreen electronic device of claim 1, wherein the first electronic device further comprises a camera integrated with the first electronic device body.

7. The multiform multiscreen electronic device of claim 1, wherein the first electronic device further comprises a wireless communications device integrated with the first electronic device body.

8. The multiform multiscreen electronic device of claim 1, wherein the first electronic device further comprises a plurality of touch-sensitive buttons integrated with the first electronic device body.

9. The multiform multiscreen electronic device of claim 1, wherein the first electronic device further comprises a battery disposed in the first electronic device body.

10. The multiform multiscreen electronic device of claim 9, wherein the first electronic device further comprises an electrical charging port integrated with the first electronic device body for direct charging of the battery.

11. The multiform multiscreen electronic device of claim 9, wherein the first electronic device further comprises contact points integrated with the first electronic device body for inductive charging of the battery.

12. The multiform multiscreen electronic device of claim 1, furthering comprising a microphone integrated with the first electronic device body.

13. The multiform multiscreen electronic device of claim 1, furthering comprising a loudspeaker integrated with the first electronic device body.

14. The multiform multiscreen electronic device of claim 1, furthering comprising a loudspeaker integrated with the third electronic device body.

15. The multiform multiscreen electronic device of claim 1, further comprising at least an arm for forming an angle brace between the first electronic device body and the second electronic device body or between the second electronic device body and the third electronic device body.

16. The multiform multiscreen electronic device of claim 1, wherein each of the first, second, and third electronic device screens has one or more screen areas, each screen area being selected from the group consisting of a display screen area, a touch screen area, and an input screen area.

17. The multiform multiscreen electronic device of claim 1, wherein each of the first, second, and third electronic device bodies has a backside made of scratch-resistant glass.

18. The multiform multiscreen electronic device of claim 1, wherein the first, second, and third electronic device screens are operatively coupled.

19. The multiform multiscreen electronic device of claim 1, wherein at least one of the first, second, and third electronic devices comprises a sensor for detecting an orientation of its respective electronic device screen.

20. The multiform multiscreen electronic device of claim 1, wherein the electronic device bodies are configurable in a form selected from the group consisting of a stacked form, a flat or tablet form, a L-shaped form, a V-shaped form, and a Z-shaped form.
